(19) United States
(12) Patent Application Publication
(10) Pub. No.: US 2022/0146678 A1
(43) Pub. Date: May 12, 2022

(54) RANGE IMAGE SENSOR AND ANGLE INFORMATION ACQUISITION METHOD

(71) Applicant: OMRON CORPORATION, Kyoto-shi, Kyoto (JP)

(72) Inventors: Hideki CHUJO, Otokuni-gun (JP); Hiroyuki TANAKA, Hikone-shi (JP); Tomohiro INOUE, Otsu-shi (JP); Masahiro KINOSHITA, Kyoto-shi (JP)

(73) Assignee: OMRON CORPORATION, Kyoto-shi, Kyoto (JP)

(21) Appl. No.: 17/436,123

(22) PCT Filed: Feb. 6, 2020
(86) PCT No.: PCT/JP2020/004577

§ 371 Date: Sep. 3, 2021

(30) Foreign Application Priority Data
Mar. 15, 2019 (JP) 2019-048113

(51) Int. Cl. G01S 17/89; G01S 7/4865; G01B 11/26; G01C 3/06

(52) U.S. Cl. CPC G01S 17/89; G01C 3/06; G01B 11/26; G01S 7/4865

(57) ABSTRACT

There is provided an imager light receiving element type of range image sensor that acquires, from a plurality of pixels, information about light received by the various pixels, the range image sensor comprising a distance information calculation unit and a memory unit. The distance information calculation unit calculates the distance to an object for each of pixels of an imaging element. The memory unit stores the distance measured for each of the pixels and an angle information acquired for each of the pixels in association with the distance.

### TECHNICAL FIELD

The present invention relates to a range image sensor and a method for acquiring angle information.

### BACKGROUND ART

In recent years there have been range image sensors that use a TOF (time of flight) method to measure the distance to an object for each of pixels and create an image (see Patent Literature 1, for example).

With a range image sensor, light is projected toward an imaging range the includes an object, the light reflected from the object is collected with a lens, and the light is made to be incident on the pixels of an imaging element. The phase difference between the incident light and the projected light is measured for each of pixels of the imaging element, and the distance to the object is sensed for each of pixels from this phase difference.

In order to generate a three-dimensional range image from the distance to the object measured for each of pixels in this way, information about the measurement direction of the distance measured for each of pixels is necessary. The value of the angle calculated in the design for each of pixels was used as this information about the measurement direction.

### CITATION LIST

### Patent Literature

Patent Literature 1: JP-A 2018-136123

### SUMMARY

### Technical Problem

However, the angle information for each of pixels may vary from one sensor to the next due to variations in the lens and assembly.

It is an object of the present invention to provide a range image sensor with which accurate angle information about the distance measurement direction can be acquired for each of pixels, as well as an angle information acquisition method.

### Solution to Problem

The range image sensor according to the first invention is an imager light receiving element type of range image sensor that acquires information about the light received by each of a plurality of pixels, the range image sensor comprising a distance calculation unit and a memory unit. The distance calculation unit calculates the distance to an object for each of pixels of a light receiving element. The memory unit stores the distance measured for each of the pixels and an angle information acquired for each of the pixels in association with the distance.

Consequently, angle information acquired for each of pixels and the distance calculated for each of pixels can be stored, so an accurate three-dimensional range image can be created.

The range image sensor according to the second invention is the range image sensor according to the first invention, further comprising a transmission unit that transmits the distance measured for each of pixels and the angle information acquired for that pixel.

Consequently, a three-dimensional range image can be created in an external device that is connected to a range image sensor.

The angle information acquisition method according to the third invention comprises a light receiving step, an image creation step, and an acquisition step. The light receiving step involves projecting light from the range image sensor onto a specific image whose position with respect to the range image sensor has been predetermined, and receiving the light reflected by the specific image with the light receiving element of the range image sensor. The image creation step involves creating a reflection intensity image corresponding to the specific image from information about the amplitude of the reflected light received by each pixel in the light receiving element. The acquisition step involves acquiring angle information about the direction in which each of the pixels measures distance, on the basis of the reflection intensity image.

In this way, a reflection intensity image corresponding to a specific image whose position with respect to the range image sensor is predetermined can be created, and angle information about the direction in which each pixel measures the distance can be sensed from the corresponding relationship between each position of the specific image and each position of the reflection intensity image corresponding to the specific image.

Therefore, accurate angle information about the distance measurement direction can be acquired for each of pixels.

The angle information acquisition method according to the fourth invention is the angle information acquisition method according to the third invention, wherein the acquisition step involves acquiring, as angle information, the direction of a prescribed position, for which the direction from the range image sensor is prescribed from out of the specific image, from the range image sensor, with respect to the pixel in the position of the reflection intensity image corresponding to the prescribed position.

Thus, the direction of a pixel at which has been detected a prescribed position where the direction from the range image sensor is defined in advance, can be acquired as angle information for measuring the distance.

The angle information acquisition method according to the fifth invention is the angle information acquisition method according to the fourth invention, wherein the angle information with respect to the pixel in the position of the reflection intensity image corresponding to an unprescribed position, for which the direction from the range image sensor is not prescribed from out of the specific image, by complementing from the angle information acquired at the pixel in the position of the reflection intensity image corresponding to the prescribed position.

Thus, angle information for pixels at which is detected an prescribed position where the direction from the range image sensor in the specific image is not prescribed, is acquired by performing complementary calculation from the angle information for the pixel where the prescribed position was detected.

The angle information acquisition method according to the sixth invention is the angle information acquisition method according to any of the third to fifth inventions, wherein the angle information includes a first angle and a second angle. The first angle is formed by the measurement direction of the various pixels with respect to a specific axis perpendicular to the light receiving surface of the light receiving element. The second angle which is the angle of the circumferential direction around the specific axis and is the rotation angle from a reference position to the measurement direction.

The measurement direction of each pixel can be prescribed by the first angle and the second angle.

The angle information acquisition method according to the seventh invention is the angle information acquisition method according to the sixth invention, wherein the specific image has a first angle image that serves as a reference in acquiring the first angle, and a second angle image that serves as a reference in acquiring the second angle.

Thus, the first angle and the second angle can be acquired for each of pixels by creating a reflection intensity image corresponding to a specific image including the two angle images.

The angle information acquisition method according to the eighth invention is the angle information acquisition method according to the seventh invention, wherein an angle formed by the specific axis and a straight line passing through a point on the first angle image and an intersection between a specific axis and the light receiving surface, and the angle is a predetermined first specific angle. A plurality of the first specific angles are provided. In the acquisition step, the first angle is acquired on the basis of the plurality of first specific angles.

Consequently, the first angle can be acquired for each of pixels by using the first angle image.

The angle information acquisition method according to the ninth invention is the angle information acquisition method according to the eighth invention, wherein the first angle image has a center point on the specific axis, and a plurality of concentric circles centered on the center point.

Thus, the first angle can be acquired for each of pixels by using an image of a plurality of concentric circles.

The angle information acquisition method according to the tenth invention is the angle information acquisition method according to the seventh invention, wherein the second angle image has a straight line in which a reference line, which is perpendicular to the specific axis from the center point on the specific axis, has been rotated by a predetermined second specific angle centered on the center point, from the reference line. A plurality of the second specific angles are provided. In the acquisition step, the second angle is acquired on the basis of the plurality of the second specific angles. The reference position is a position on the reference line.

Consequently, the second angle can be acquired for each of pixels by using the second angle image.

The angle information acquisition method according to the eleventh invention is the angle information acquisition method according to the tenth invention, wherein the second angle image has a plurality of straight lines disposed radially around a center point on the specific axis.

Thus, the first angle can be acquired for each of pixels by using an image of a plurality of straight lines disposed radially.

The angle information acquisition method according to the twelfth invention is the angle information acquisition method according to any of the third to eleventh inventions, wherein the specific image is formed on the image formation surface. The image formation surface is disposed opposite the range image sensor.

Angle information can be acquired for each of pixels by projecting light onto the specific image in a state in which the image formation surface on which the specific image is formed is positioned with respect to the range image sensor.

The angle information acquisition method according to the thirteenth invention is the angle information acquisition method according to any of the third to eleventh inventions, wherein the specific image is an image formed by moving the range image sensor with respect to an image formation surface on which points are formed.

A specific image can be virtually formed by moving the range image sensor side with respect to the points. Also, angle information can be acquired for each of pixels by prescribing the rotation angle on the range image sensor side in advance.

The range image sensor according to the fourteenth invention acquires the angle information about the various pixels by the angle information acquisition method according to any of claims 3 to 13, the range image sensor comprising a projection unit, a light receiving, a distance calculation unit, and a memory unit. The projection unit projects light onto an object. The light receiving unit has a light receiving lens that collects light reflected by the object, and a light receiving element that receives light that has passed through the light receiving lens. The distance calculation unit calculates the distance to the object for each of pixels of the light receiving element. The memory unit stores the distance measured for each of the pixels and an angle information acquired for each of the pixels in association with the distance.

Consequently, angle information and distance can be stored for each of pixels, so an accurate three-dimensional range image can be created.

The range image sensor according to the fifteenth invention is the range image sensor according to the fourteenth invention, further comprising a transmission unit. The transmission unit transmits the distance measured for each of pixels and the angle information acquired for the pixels.

Consequently, a three-dimensional range image can be created in an external device connected to a range image sensor.

### Advantageous Effects

The present invention provides an angle information acquisition method and a range image sensor with which accurate angle information about the distance measurement direction can be acquired for each of pixels.

### BRIEF DESCRIPTION OF DRAWINGS

FIG. 1 is a block diagram of the configuration of a TOF sensor in an embodiment of the present invention;

FIG. 2 is a graph of the projected light wave and the received light wave;

FIGS. 3A to 3D are diagrams illustrating three-dimensional information data;

FIG. 4 is a diagram of the disposition relationship between a chart and a TOF sensor in the angle information acquisition method according to an embodiment of the present invention;

FIG. 5 is a flowchart showing the operation of acquiring angle information for pixels that lie on a chart line in the TOF sensor of FIG. 1;

FIG. 6 is a diagram showing a chart reading image produced by the imaging element of the TOF sensor of FIG. 1;

FIG. 7 is a diagram showing a chart reading image produced by the imaging element of the TOF sensor of FIG. 1;

FIG. 8 is a flowchart showing the operation of acquiring angle information for pixels that do not lie on the chart line;

FIG. 9 is a diagram illustrating the operation of acquiring angle information for pixels that do not lie on the chart line;

FIG. 10 is a diagram showing the operation of reading angle information for the pixels of a TOF sensor in a modification example of an embodiment of the present invention;

FIG. 11 is a schematic view showing the disposition of a chart, a lens, and an imaging element; and

FIG. 12A is an image diagram on the imaging element when an inspection chart is read in a state in which the lens is not laterally displaced with respect to the imaging element, and FIG. 12B is an image diagram on the imaging element when an inspection chart is read in a state in which the lens is laterally displaced with respect to the imaging element.

### DESCRIPTION OF EMBODIMENTS

An TOF sensor, which is an example of the range image sensor according to an embodiment of the present invention, and a TOF sensor angle information acquisition method, will be now described with reference to the drawings.

### TOF Sensor Configuration

A TOF sensor 10 (an example of a range image sensor) in this embodiment is an imager light receiving element type, and receives the reflected light of the light emitted from a light projecting unit 11 toward a measurement object 100, and displays the distance to the measurement object 100 according to the time of flight (TOF) of the light from when the light is emitted until when the light is received.

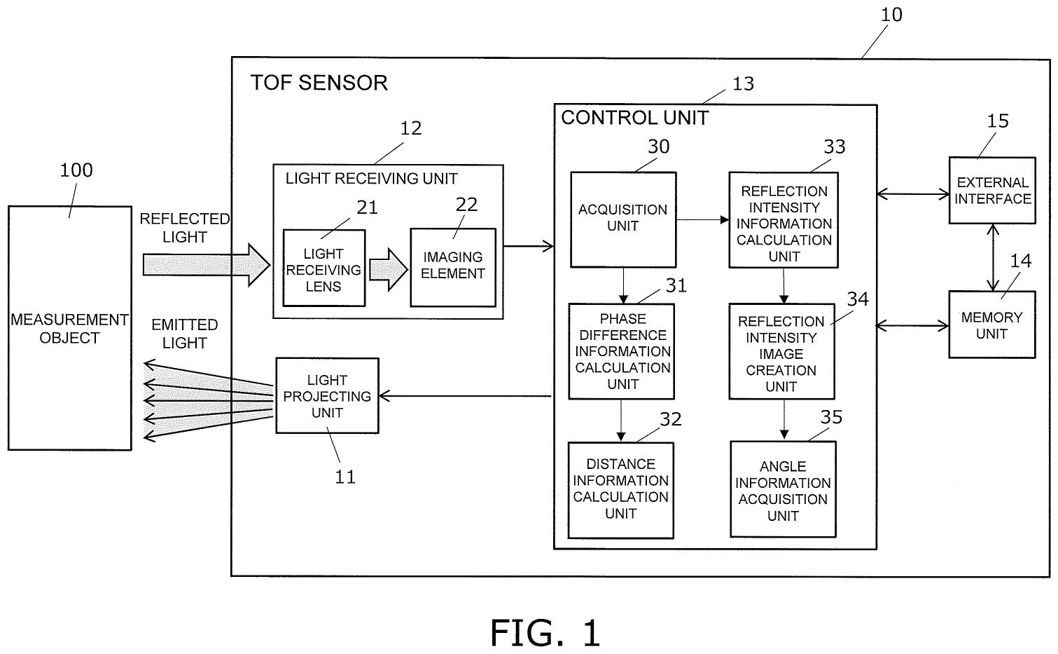

As shown in FIG. 1, the TOF sensor 10 comprises a light projecting unit 11, a light receiving unit 12, a control unit 13, a memory unit 14, and an external interface 15 (an example of a transmitting unit).

The light projecting unit 11 irradiates the measurement object 100, which has an LED (not shown), with the desired light that has been processed at a specific modulation frequency (such as 12 MHz). The light projecting unit 11 is provided with a light projection lens (not shown) that collects the light emitted from the LED and guides the light in the direction of the measurement object 100.

The light receiving unit 12 receives the reflected light of the light projected from the light projecting unit 11 onto the measurement object 100. The light receiving unit 12 has a light receiving lens 21 and an imaging element 22 (an example of a light receiving element). The light receiving lens 21 is provided to receive the reflected light that is emitted from the light projecting unit 11 at the measurement object 100 and then reflected by the measurement object 100, and to guide this reflected light to the imaging element 22.

The imaging element 22 has a plurality of pixels, and as shown in FIG. 1, the reflected light received by the light receiving lens 21 is received at each of the plurality of pixels, and a photoelectrically converted electric signal is transmitted to the control unit 13.

As shown in FIG. 1, the control unit 13 is connected to the light projecting unit 11, the imaging element 22, the memory unit 14, and the external interface 15. The control unit 13 reads various programs stored in the memory unit 14 and controls the emission of light by the light projecting unit 11.

Furthermore, the control unit 13 receives data at the point when light is received by the plurality of pixels included in the imaging element 22, etc., and after the light has been emitted from the light projecting unit 11 toward the measurement object 100, the distance to the measurement object 100 is measured on the basis of the time of flight of the light until the reflected light is received at the imaging element 22. The measurement result is transmitted from the control unit 13 to the memory unit 14 and stored in the memory unit 14.

The control unit 13 is constituted by a processor or the like, and has an acquisition unit 30, a phase difference information calculation unit 31, a distance information calculation unit 32 (an example of a distance calculation unit), a reflection intensity information calculation unit 33, a reflection intensity image creation unit 34, and an angle information acquisition unit 35.

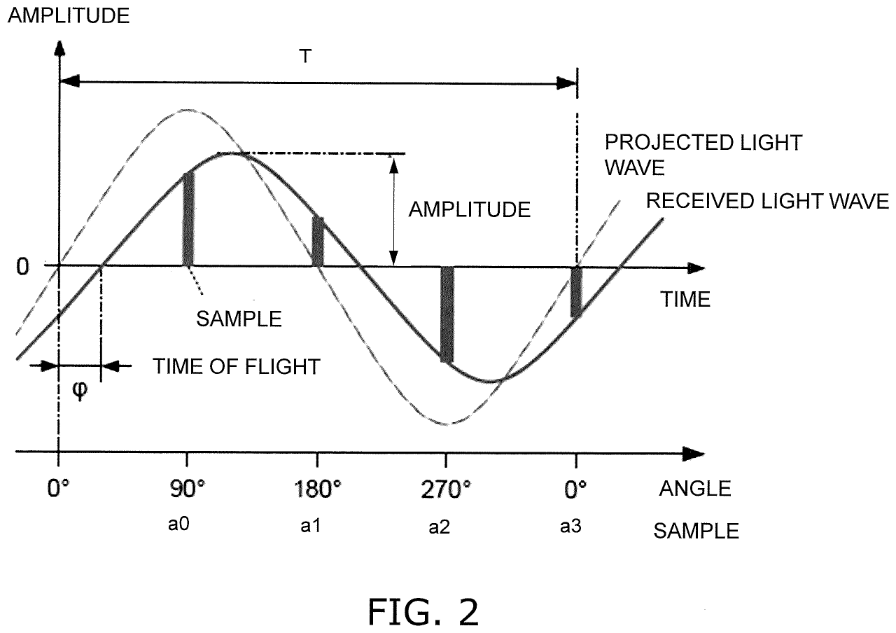

FIG. 2 is a graph of the projected light wave and the received light wave.

The acquisition unit 30 acquires a0, a1, a2, and a3 outputted from the imaging element 22 for each of pixels of the imaging element 22. a0 to a3 are amplitudes at points where the received light wave is sampled four times at 90 degree intervals.

The phase difference information calculation unit 31 calculates the phase difference ϕ between the light projected wave emitted from the light projecting unit 11 and the received light wave received by the imaging element 22 for each of pixels of the imaging element 22. The phase difference ϕ is expressed by the following relational formula.

Phase difference Φ=a tan(y/x) (1)

(X=a2−a0, y=a3−a1)

The distance information calculation unit 32 calculates the distance from a pixel to the measurement object 100 for each of pixels on the basis of the calculated phase difference ϕ.

The conversion formula from the phase difference Φ to the distance D is expressed by the following relational formula (2).

D=(C/(2×f_{LED}))×(Φ/2π)+D_{OFFSET} (2)

(C is the speed of light (≈3×10⁸ m/s), f_{LED} is the frequency of the LED projected light wave, and D_{OFFSET} is the distance offset.)

The reflection intensity information calculation unit 33 calculates the reflection intensity value S for each of pixels from the reflection intensity at the four sampled points of the received light wave. More specifically, the reflection intensity information calculation unit 33 finds the reflection intensity value S for each of pixels from the following relational formula (3). This reflection intensity value S indicates the intensity of the reflected light (received light) from the object.

$$\begin{matrix}[ Mathematical Formula 1 ] & \\ S = \frac{\sqrt{{( a 2 - a 0 )}^{2} + {( a 3 - a 1 )}^{2}}}{2} & ( 3 )\end{matrix}$$

The reflection intensity image creation unit 34 creates a reflection intensity image from the calculated reflection intensity value S. The reflection intensity image creation unit 34 images the intensity of the reflected light from an inspection chart 50 (discussed below) formed in white and black, which is used in acquiring angle information for each of pixels. As will be described in detail below, the angle information is information about the measurement direction of the distance for each of pixels.

The angle information acquisition unit 35 acquires angle information for each of pixels on the basis of a reflection intensity image in which amplitude is imaged.

When the distance information calculation unit 32 calculates distance information to the measurement object 100 for each of pixels, the distance information is stored in the memory unit 14 in association with the angle information stored in the memory unit 14.

The memory unit 14 is connected to the control unit 23 and the external interface 15, and stores the angle information for each of pixels acquired by the angle information acquisition unit 35 and the distance information associated with the angle information. The memory unit 14 also stores a control program for controlling the light projecting unit 11 and the imaging element 22, the amount of reflected light sensed at the imaging element 22, the light receiving timing, and other such data. In addition, the memory unit 14 stores information about the inspection chart 50 (discussed below).

The external interface 15 transmits the distance information measured for each of pixels and the angle information for each of pixels to an external computer or the like in a state of being associated with each other. The angle information and the distance information for each of pixels become three-dimensional information data, and an external computer creates a three-dimensional range image on the basis of the three-dimensional information data, and displays this image on a display screen.

### Structure of 3D Information Data

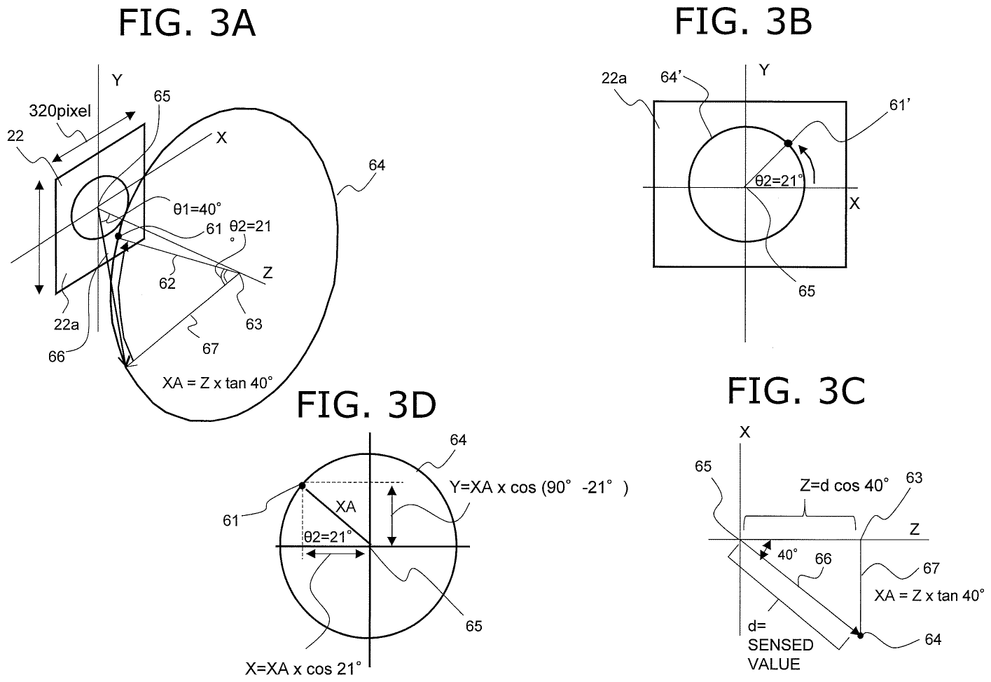

Next, the three-dimensional information data will be described. FIGS. 3A to 3D are diagrams illustrating the three-dimensional information data.

The angle information includes a first angle θ1 (see FIG. 3A) and a second angle θ2 (see FIG. 3B). The method for acquiring the first angle θ1 and the second angle θ2 will be described in detail below.

The distance d is a value measured by the TOF sensor 10. From these three values is found a position in xyz coordinates indicating the three-dimensional position of the captured image.

FIG. 3A shows the imaging element 22. The imaging element 22 has a size of 120 pixels in the vertical direction and 320 pixels in the horizontal direction, for example. The horizontal direction of the light receiving surface 22a of the imaging element 22 is defined as the X axis, and the vertical direction as the Y axis. Also, the axis perpendicular to the light receiving surface 22a of the imaging element 22 is defined as the Z axis. Here, the position of a point 61 in three-dimensional space is indicated by using the first angle θ1, the second angle θ2, and the distance d.

A circle 64 passing through the point 61 is drawn centering on a point 63 that intersects the Z axis and a line 62 extending perpendicular to the Z axis from the point 61. Here, the first angle θ1 is an angle formed by the Z axis and a straight line 66 that links the circle 64 and an origin 65 intersect the Z axis and the light receiving surface 22a. The origin 65 may be the center point of the light receiving surface 22a. In FIG. 3A, the first angle θ1 is set to 40° as an example. That is, the first angle θ1 is 40° at any point on the circle 64.

The second angle θ2 is an angle formed by the line 62 and a straight line 67 that passes through the point 63 and is parallel to the X axis. In FIG. 3A, the second angle θ2 is set to 21° as an example.

FIG. 3B is a diagram showing the light receiving surface 22a of the imaging element 22. As shown in FIG. 3B, a circle 64′ corresponding to the circle 64, a point 61′ corresponding to the point 61, and the second angle θ2 are shown on the light receiving surface 22a.

In finding the Z value of the three-dimensional information, this value can be found without using the second angle θ2. FIG. 3C is a plan view of FIG. 3A. That is, as shown in FIG. 3C, since the length of the straight line 66 from the origin 65 to the circle 64 is obtained as the sensed distance d, the Z value of the point 61 from the origin can be found at dcos 40°.

If we let XA be the length of the line segment from the point 63 on the straight line 67 to the circle 64, then the length of XA can be found from XA=Z×tan 40°.

FIG. 3D is a rear view of the circle 64 in FIG. 3A as seen from the opposite side from the imaging element 22. As shown in FIG. 3D, the X value of the x coordinate of the point 61 can be found from X=XA×cos 21°. Furthermore, the Y value of the y coordinate of the point 61 can be found from Y=XA×cos (90°-21°).

As described above, the three-dimensional coordinate values (X, Y, and Z) can be calculated from the values of the first angle θ1, the second angle θ2, and the measured distance d. Therefore, a three-dimensional range image can be created from the first angle θ1 and the second angle θ2 acquired for each of pixels, and the measured distance d.

### Angle Information Acquisition Method

The method for acquiring angle information for each of pixels of the TOF sensor 10 in this embodiment will now be described, and an example of the angle information acquisition method of the present invention will be described at the same time.

### Inspection Chart

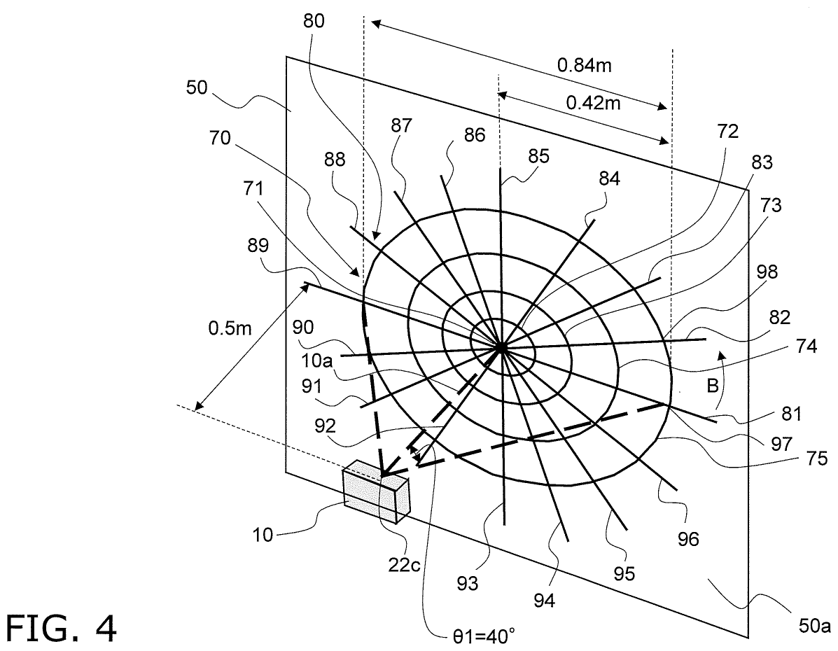

First, an inspection chart 50 (an example of the specific image) used in the angle information acquisition method will be described. FIG. 4 is an oblique view of the inspection chart 50 and the TOF sensor 10. The inspection chart 50 and the TOF sensor 10 are disposed opposite each other. The image formation surface of the inspection chart 50 is shown as 50a.

The inspection chart 50 (an example of the specific image) shown in FIG. 4 has a concentric circle chart 70 (an example of the first angle image) and a radial chart 80 (an example of the second angle image).

A plurality of concentric circles 72, 73, 74, and 75 centered on a specific center point 71 are drawn on the concentric circle chart 70. The circles 72, 73, 74, and 75 increase in diameter in that order.

The TOF sensor 10 is positioned with respect to the inspection chart 50 so that the central axis 10a perpendicular to the light receiving surface 22a passes through the center point 71 from the center of the light receiving surface 22a of the imaging element 22. The center of the light receiving surface 22a is shown as the center point 22c.

The angle formed by the central axis 10a and a line connecting the center point 22c and a point on any of the circles 72, 73, 74, and 75 indicates the first angle θ1. For example, with the circle 72 the first angle θ1 is set to 10 degrees, with the circle 73 the first angle θ1 is set to 20 degrees, with the circle 74 the first angle θ1 is set to 30 degrees, and with the circle 75 the first angle θ1 is set to 40 degrees. These angles of 10°, 20°, 30°, and 40° correspond to an example of the plurality of first specific angles prescribed in advance. Also, as an example, the diameter of the circle 75 is 0.84 m, and the radius can be set to 0.42 m. Also, the distance between the TOF sensor 10 and the inspection chart 50 along the central axis 10a can be set to 0.5 m.

Lines 81 to 96 extending radially from the center point 71 are drawn on the radial chart 80.

Also, a line extending in one horizontal direction from the center point 71 serves as a reference line 81. The angle formed by the reference line 81 and each of the lines 82 to 96 obtained by rotating the reference line 81 counterclockwise (see arrow B) in FIG. 4 around the center point 71 is shown as the second angle θ2. For example, the line 82 is a line in which the second angle θ2 is set to 22.5 degrees and which has been rotated counterclockwise by 22.5 degrees from the reference line 81. The line 83 is a line in which the second angle θ2 is set to 45 degrees and which has been rotated counterclockwise by 45 degrees from the reference line 81. The line 84 is a line in which the second angle θ2 is set to 67.5 degrees and which has been rotated counterclockwise by 67.5 degrees from the reference line 81. In this way, from the line 82 to the line 96, the rotation angle from the reference line 81 increases counterclockwise by 22.5 degrees. For example, the line 96 is a line in which the second angle θ2 is set to 337.5 degrees and which has been rotated counterclockwise by 337.5 degrees from the reference line 81. These angles of 0°, 22.5°, 45°, 67.5°, 90°, 112.5°, 135°, 157.5°, 180°, 202.5°, 225°, 247.5°, 270°, 292.5°, 315°, and 337.5° correspond to an example of the plurality of second specific angles that have been prescribed in advance.

For example, the position of the intersection 97 of the reference line 81 and the circle 75 can be indicated by θ1=40° and θ2=0°. Also, the position of the intersection 98 of the line 81 and the circle 75 can be indicated by θ1=40° and θ2=22.5°. Acquisition of Angle Information for Pixels Located on Chart Lines

The acquisition of angle information about pixels where the distance from the TOF sensor 10 to a point on the line of the inspection chart 50 is detected will now be described.

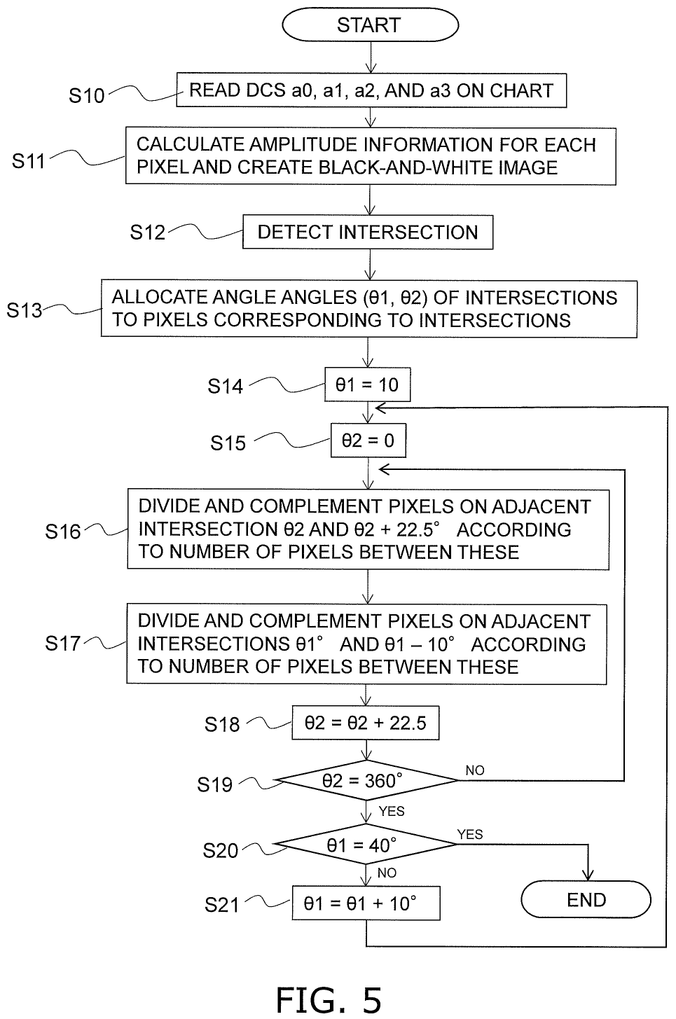

FIG. 5 is a flowchart showing the angle information acquisition method in this embodiment.

First, in step S10 (an example of the light receiving step), light is projected from the TOF sensor 10 with respect to the inspection chart 50 positioned from the TOF sensor 10, and the reflection intensity information calculation unit 33 acquires a0, a1, a2, and a3 shown in FIG. 2 for each of pixels of the imaging element 22. This step S10 corresponds to an example of the light receiving step.

Then, in step S11, the reflection intensity information calculation unit 33 calculates amplitude information for each of pixels, and the reflection intensity image creation unit 34 creates a black-and-white image as a reflection intensity image. This step S11 corresponds to an example of the image creation step.

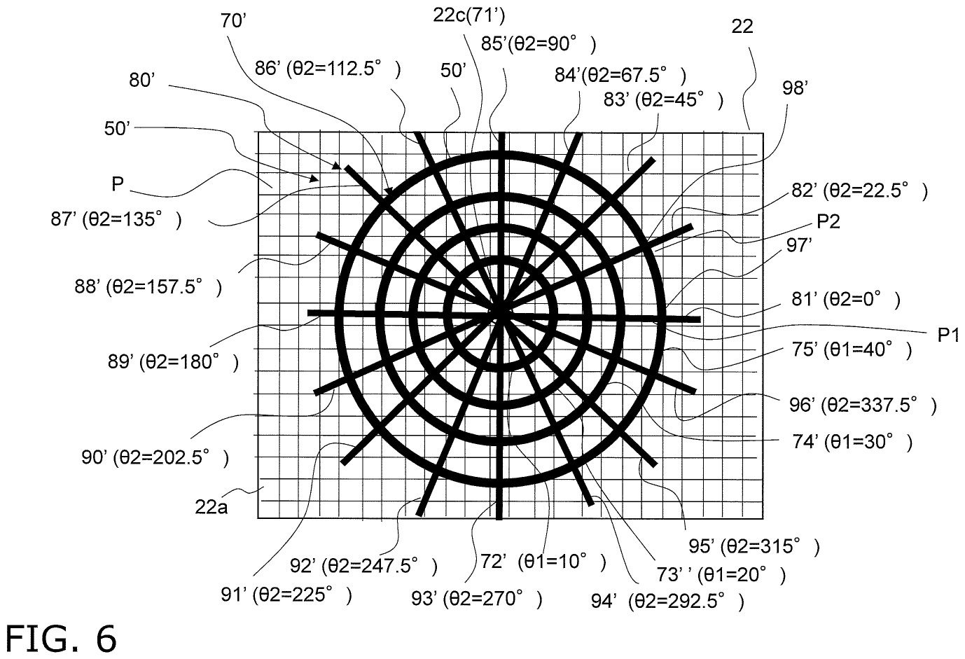

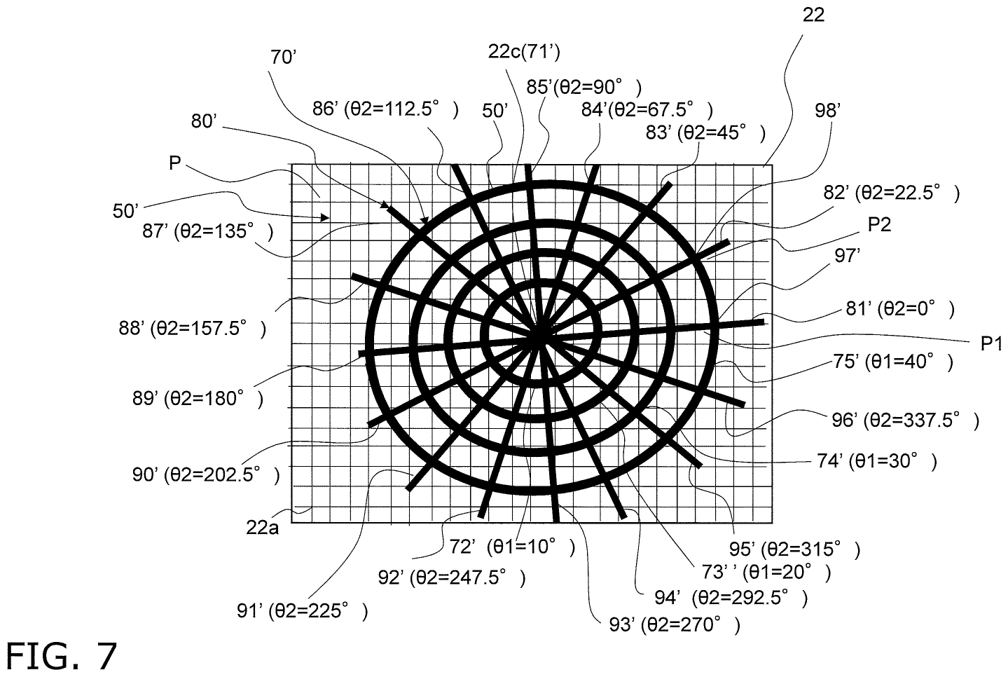

FIGS. 6 and 7 are diagrams showing a reading image of the inspection chart 50 by the imaging element 22. FIGS. 6 and 7 show reading images when the light receiving surface 22a of the imaging element 22 is viewed from the opposite side from the light receiving surface 22a. The black-and-white chart image 50′ includes a concentric circle image 70′ and a radial image 80′. The concentric circle image 70′ is a reflection intensity image corresponding to the concentric circle chart 70. The radial image 80′ is a reflection intensity image corresponding to the radial chart 80. The images corresponding to the center point 71 and the circles 72 to 75 of the concentric circle chart 70 of the inspection chart 50, and to the lines 81 to 96 of the radial chart 80 are the point image 71′, the circle images 72′ to 75′, and the line images 81′ to 96′, each of which has a prime symbol added its number. Also, one square formed on the light receiving surface 22a of the imaging element 22 indicates one pixel P. Although the imaging element 22 actually has 120 pixels in the vertical direction and 320 pixels in the horizontal direction, the pixels P are described as being larger for the sake of explanation.

Also, in FIG. 6, the concentric circle image 70′ is formed in a circular shape on the imaging element 22, but in FIG. 7, it is formed in an elliptical shape. The difference shown in FIGS. 6 and 7 is due to variations in the assembly of the light receiving lens 21 to the imaging element 22 for each TOF sensor 10, etc., but when converted into three-dimensional information, the same range image can be acquired by both TOF sensors 10 by acquiring angle information for each of pixels of each TOF sensor 10.

Next, in step S12, the angle information acquisition unit 35 detects an intersection (an example of the prescribed position) in the black-and-white chart image 50′. An intersection here is each intersection between the concentric circle image 70′ and the radial image 80′. The angle information acquisition unit 35 detects the intersections 97′ and 98′. The intersections 97′ and 98′ correspond to the images of the intersections 97 and 98 of the inspection chart 50 shown in FIG. 4.

Next, in step S13, the angle information acquisition unit 35 allocates the angles (01, 02) of the intersections to the pixels P corresponding to the intersections. The angle information acquisition unit 35 can recognize the first angle θ1 of the center point image 71′ and each of the circle images 72′ to 75′ of the created concentric circle image 70′, and the second angle θ2 of each of the line images 81′ to 96′ of the created radial image 80′ on the basis of the information in the chart 50 stored in the memory unit 14, so angle information at each intersection can be acquired.

Let us use the intersection 97′ and the intersection 98′ as an example. The first angle θ1 of the pixel P (labeled as P1) where the intersection 97′ is located is assigned 40°, which is the first angle θ1 of the intersection 97, and the second angle θ2 is assigned 0°, which is the second angle θ2 of the intersection 97. Also, the first angle θ1 of the pixel P (labeled as P2) where the intersection 98′ is located is assigned 40°, which is the first angle θ1 of the intersection 98, and the second angle θ2 is assigned 22.5°, which is the second angle θ2 of the intersection 98. Consequently, angle information is assigned to the pixels P at all the intersections in the concentric circle image 70′ and the radial image 80′.

Next, in step S14, the angle information acquisition unit 35 sets θ1 to 10°.

Next, in step S15, the angle information acquisition unit 35 sets θ2 to 0°.

Next, in step S16, the angle information acquisition unit 35 divides and complements the pixels on θ2 and θ2+22.5°, which are adjacent intersections, according to the number of pixels in between them. That is, angle information about the pixels along the circle image 72′ of θ1=10°, from the intersection of the line image 81′ and the circle image 72′ of θ2=0° up to the intersection of the line image 82′ and the circle image 72′ of θ2=22.5°, is complemented using angle information about the intersection of the line image 81′ and the circle image 72′, as well as angle information about the intersection of the line image 82′ and the circle image 72′. Points outside the intersections in the black-and-white chart image 50′ correspond to an example of unprescribed positions.

More specifically, when there are four pixels between θ2 and θ2+22.5°, the θ2 of complemented pixels will be θ2+22.5°/5, θ2+(22.5°/5)×2, θ2+(22.5°/5)×3, and θ2+(22.5°/5)×4. That is, the angle information (θ1, θ2) for four pixels between the intersection where the angle information (θ1, θ2) is (10°, 0°) and the intersection where the angle information (θ1, θ2) is (10°, 22.5°) will be (10°, 4.5°), (10°, 9°), (10°, 13.5°), and (10°, 18°), respectively.

Next, in step S17, the angle information acquisition unit 35 divides and complements the pixels located on the adjacent intersection θ1-10° and θ1 according to the number of pixels in between them. That is, angle information for the pixels between the center point 22c at θ1=0° and the intersection of the line image 81′ and the circle image 72′ along the line image 81′ of θ2=0 is complemented by using the angle information for the center point 22c and the angle information for the intersection of the line image 81′ and the circle image 72′.

More specifically, when there are four pixels between θ1 and θ1-10°, the complemented pixels θ1 will be θ1-10°+10°/5, θ1-10°+(10°/5)×2, θ1-10°+(10°/5)×3, and θ1-10°+(10°/5)×4. That is, the angle information (θ1, θ2) for the four pixels between the center point 22c where the angle information (θ1, θ2) is (0°, 0°) and the intersection where the angle information (θ1, θ2) is (10°, 0°) will be (2°, 0°), (4°, 0°), (6°, 0°), and (8°, 0°), respectively.

Next, in step S18, the angle information acquisition unit 35 sets θ2 to θ2+22.5°. Now, since θ2=0°, we will let θ2=22.5°.

Next, in step S19, the angle information acquisition unit 35 determines whether or not θ2=360°. Here, since θ2 is 22.5° and has not yet reached 360°, the process goes back to step S16. In step S16, complementation is performed on the pixels located along the circle image 72′ of θ1=10° and between the intersection where the angle information (θ1, θ2) is (10°, 22.5°) and the intersection where the angle information (θ1, θ2) is (10°, 45°).

Next, in step S17, complementation is performed on the pixels located along the line image 82′ of θ2=22.5° and between the intersection where the angle information (θ1, θ2) is (0°, 0°) and the intersection where the angle information (θ1, θ2) is (10°, 22.5°).

These steps S16 and S17 are performed until θ2=360°. As a result, complementation is performed on the pixels on the circle image 72′ and on the line segment from the center point 22c to the intersection of the line images 81′ to 96′ with the circle image 72′.

Next, in step S20, the angle information acquisition unit 35 determines whether or not the first angle θ1 is 40°. Here, since θ1 is 10° and has not yet reached 40°, the angle information acquisition unit 35 sets θ1 to θ1+10° (20° in step S21.

Next, going back to step S15, the angle information acquisition unit 35 sets the second angle θ2 to 0°.

Next, in step S16, the angle information acquisition unit 35 complements and calculates the angle information for each of the pixels located between the intersection where the angle information is (20°, 0°) and the intersection where the angle information is (20°, 22.5°).

Next, in step S17, the angle information acquisition unit 35 complements and calculates the angle information for each of the pixels located between the intersection where the angle information is (10°, 0°) and the intersection where the angle information is (20°, 0°).

These steps S16 and S17 are repeated until 02 reaches 360° in step S19. As a result, complementation is performed on the pixels on the circle image 72′ and on the line segment from the center point image 71′ to the intersection of the line images 81′ to 96′ with the circle image 72′.

Next, since θ1 has not yet reached 40° in step S20, in step S21 θ1 is increased by another 10°, and steps S15 to S19 are carried out at θ1=30°. Consequently, complementation is performed on the pixels on the circle image 73′ and on the line segment from the intersection of the line images 81′ to 96′ with the circle images 72′ to the intersection with the circle image 73′.

Next, since θ1 has not yet reached 40° in step S20, in step S21 θ1 is increased by another 10°, and steps S15 to S19 are performed at θ1=40°. Consequently, complementation is performed on the pixels on the circle image 74′ and on the line segment from the intersection of the line images 81′ to 96′ with the circle image 73′ to the intersection with the circle image 74′.

Then, since θ1=40° in step S20, the operation of acquiring angle information about the pixels on the chart line comes to an end.

The above operation allows angle information about the pixels P located on all the circle images 72′ to 74′ and all the lines of the line images 81′ to 96′ to be acquired. In addition, steps S12 to S21 correspond to an example of the acquisition step.

### Acquisition of Angle Information of Pixels Not Located on Chart Line

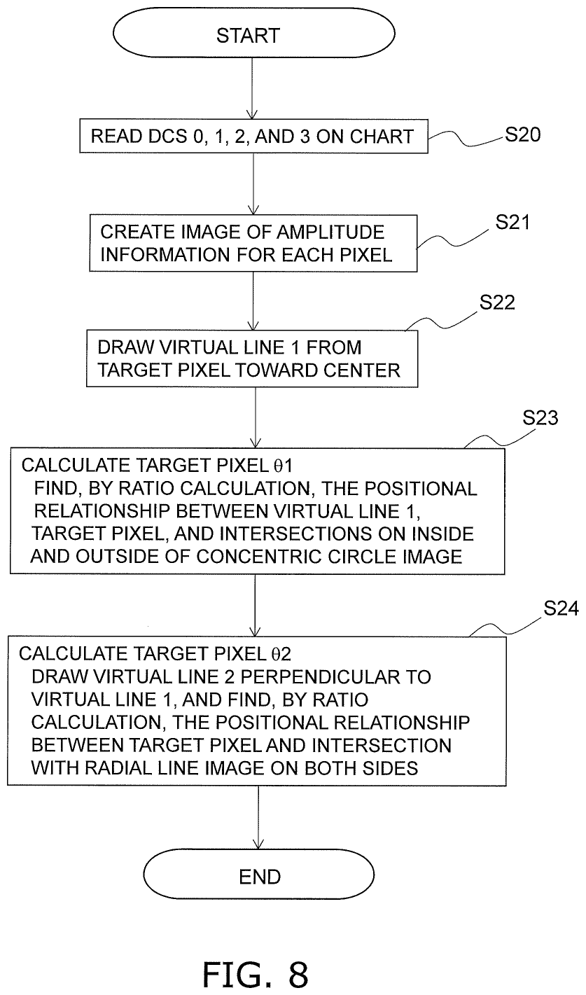

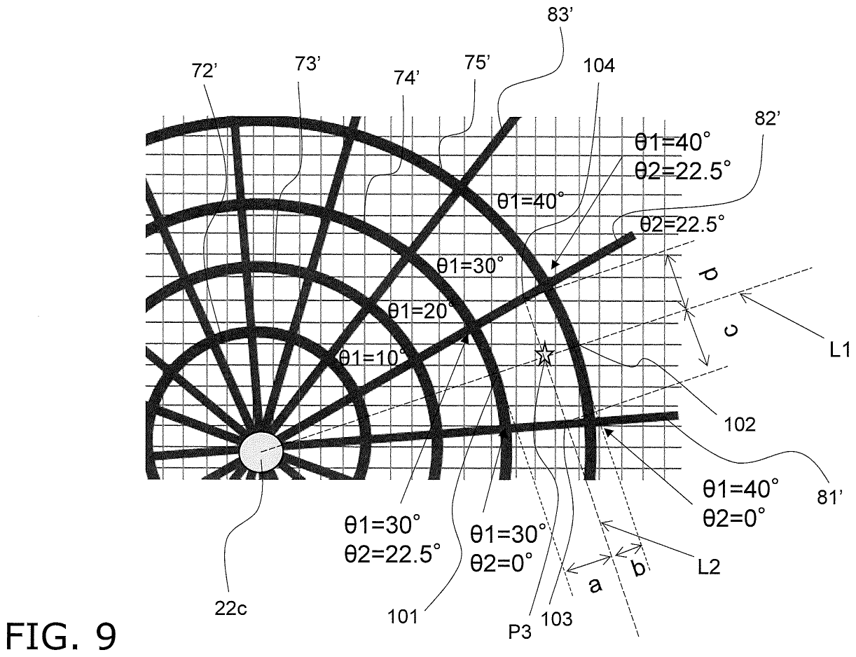

FIG. 8 is a flowchart showing the operation of acquiring angle information for pixels not located on any line of the chart. FIG. 9 is a diagram illustrating the operation of acquiring angle information for pixels not located on any line of the chart. FIG. 9 is also a detail view of FIG. 6.

Since steps S20 and S21 are the same as steps S10 and S11 described above, they will not be described again.

Next, in step S22, the angle information acquisition unit 35 draws a virtual line L1 (see FIG. 9) from the target pixel toward the center point 22c, as shown in FIG. 9. The target pixel is labeled as P3 in FIG. 9.

Here, when the operation of acquiring angle information for a pixel not located on a line is performed after angle information has been acquired for a pixel located on a line as discussed above, the target pixel will be a pixel that is inside the circle image 75′ and for which angle information has not been acquired. Also, in this case, since the amplitude information has already been imaged in steps S10 and S11 of FIG. 8, steps S20 and S21 in FIG. 9 can be omitted.

On the other hand, when the operation of acquiring angle information for a pixel not located on a line is performed without acquiring angle information for a pixel located on the line as discussed above, the target pixel will be a pixel that is not located on a line inside the circle image 75′, and steps S20 and S21 in FIG. 9 are executed.

Next, in step S23, the angle information acquisition unit 35 calculates and acquires the first angle θ1 of the target pixel P3. More specifically, the first angle θ1 is calculated by finding, as a ratio, the positional relationship between the intersection of the virtual line L1 and the inner circle image closest to the target pixel P3, the intersection of the virtual line L1 and the outer circle image closest to the target pixel P3, and the target pixel P3.

FIG. 9 shows the intersection 101 between the virtual line L1 and the inner circle image 74′ closest to the target pixel P3, and the intersection 102 between the virtual line L1 and the outer circle image 75′ closest to the target pixel P3. If we let a:b be the ratio of the length from the intersection 101 along the virtual line L1 to the target pixel P3 and the length from the intersection 102 along the virtual line L1 to the target pixel P3, then the first angle θ1 can be calculated from the following formula (4).

θ1=30°+(40°−30°)×a/(a+b) (4)

Next, in step S24, the angle information acquisition unit 35 calculates and acquires the second angle θ2 of the target pixel P3. More specifically, the second angle θ2 is calculated by drawing a virtual line L2 perpendicular to the virtual line L1, and finding, by ratio calculation, the positional relationship between the intersection of the line images on both sides and the target pixel P3.

FIG. 9 shows the intersections 103 and 104 between the virtual line L2 perpendicular to the virtual line L1 and the line images 81′ and 82′ on both sides of the target pixel P3. If we let c:d be the ratio of the length from the intersection 103 along the virtual line L2 to the target pixel P3 and the length from the intersection 104 along the virtual line L2 to the target pixel P3, then the second angle θ2 can be calculated from the following formula (5).

θ2=0°+(22.5°−0°)×c/(c+d) (5)

The operation ends once these steps S22 to S24 have been performed for all of the target pixels.

The above operation allows angle information (θ1, θ2) to be acquired even for pixels that are not located on a line in the chart.

As described above, the angle information (θ1, θ2) is acquired for each of pixels, and the acquired angle information (θ1, θ2) is stored in the memory unit 14 as an angle table.

On the other hand, if the TOF sensor 10 is operated to sense the distance to the measurement object 100, the sensed distance d for each of pixels is stored in the memory unit 14 in association with the angle information (θ1, θ2) of that pixel.

The sensed distance d and the angle information (θ1, θ2) for each of pixels are then transmitted from the external interface 15 to an external PC or the like.

The external PC can create a three-dimensional range image on the basis of the sensed distance d and the angle information (θ1, θ2) for each of pixels.

### Other Embodiments

An embodiment of the present invention was described above, but the present invention is not limited to or by the above embodiment, and various modifications are possible without departing from the gist of the invention.

(A)

In the above embodiment, the TOF sensor 10 outputs the sensed distance d and the angle information (θ1, θ2) from the external interface 15, and a three-dimensional range image is created by an external PC, but a three-dimensional range image may instead be created and in the TOF 10, and the three-dimensional range image thus created may be outputted to the outside.

(B)

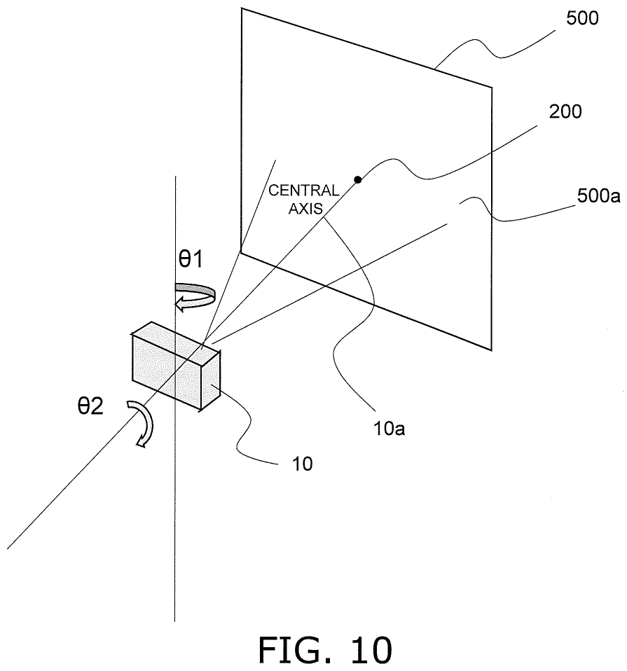

In the above embodiment, the inspection chart 50 has a concentric circle chart 70 and a radial chart 80, and the chart is read by the fixed TOF sensor 10, but this is not the only option. For instance, as shown in FIG. 10, a point 200 may be drawn on an image formation surface 500a of an inspection chart 500, and the point 200 may be read while rotating the TOF sensor 10. That is, the point 200 is read by rotating the TOF sensor 10 by the same angle (θ1, θ2) as in the concentric circle chart 70 and the radial chart 80.

In order to obtain the same data as in the inspection chart 50, the number of readings will need to be the same as the number of intersections.

Also, positioning is performed in a state in which the central axis 10a formed perpendicular to the light receiving surface 22a passes through the point 200 from the center of the light receiving surface 22a of the imaging element 22 of a TOF sensor 20, and the TOF sensor 20 is rotated from that state.

(C)

In the above embodiment, the inspection chart 50 has a concentric circle chart 70 and a radial chart 80, but this is not the only option. For instance, a plurality of points for which the value of the angle (θ1, θ2) is prescribed may be drawn on the chart. The angle information for pixels not located at these points may be calculated from the angle information located at the points by complementary calculation.

(D)

Also, in the above embodiment, in the reflection intensity image of the imaging element 22, the center point 71 of the image in the inspection chart 50 is located at the center point 22c of the light receiving surface 22a of the imaging element 22, but the present invention is applicable even if lateral displacement of the lens causes the center point 71 of the image of the inspection chart 50 not to be located at the center point 22c of the light receiving surface 22a.

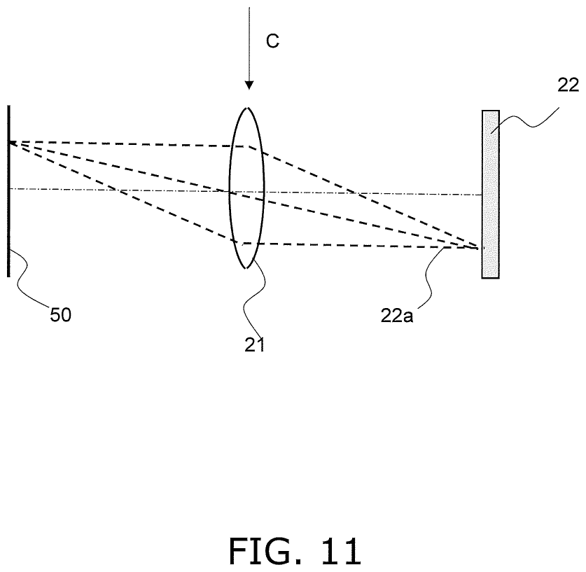

FIG. 11 is a schematic diagram of the disposition of the inspection chart 50, the light receiving lens 21, and the imaging element 22. As shown by the arrow C in FIG. 11, if the light receiving lens 21 is laterally displaced with respect to the imaging element 22 during assembly, the image captured by the imaging element 22 will be offset. For example, assuming that the imaging element 22 is 10 μm/pixel, an offset of 100 μm will result in an offset of 10 pixels.

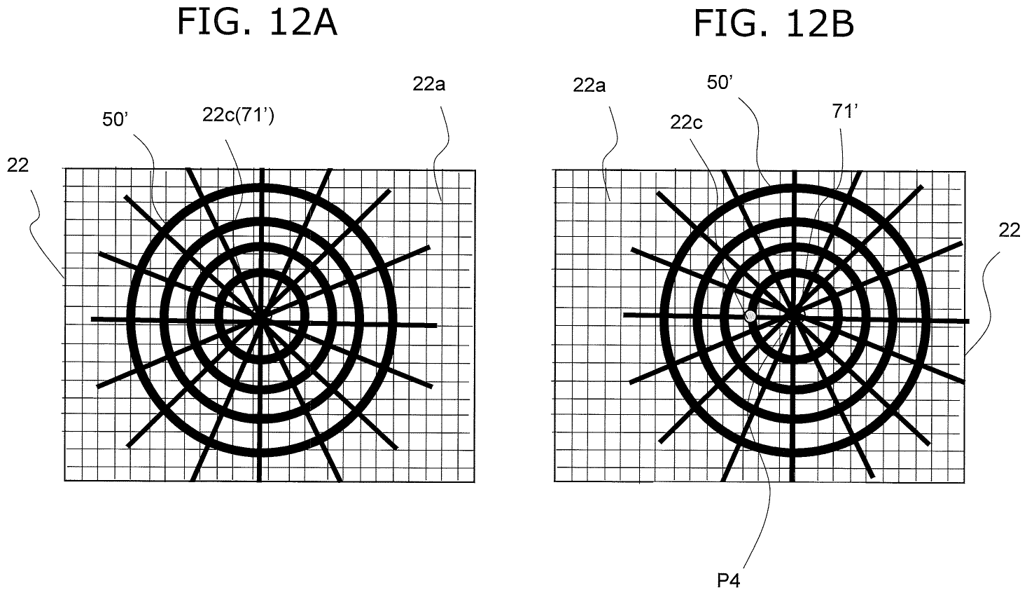

FIG. 12A is an image diagram on the imaging element 22 when the inspection chart 50 is read in a state where the light receiving lens 21 is not laterally displaced. FIG. 12B is an image diagram on the imaging element 22 when the inspection chart 50 is read in a state where the light receiving lens 21 is laterally displaced. As shown in FIG. 12B, there is positional deviation of the point 72′, which is the reading image of the center point 71 in the inspection chart 50, from the center point 22c of the light receiving surface 22a.

When this deviation occurs, the angle information (θ1, θ2) for the pixel P4 at the position of the point 72′ is acquired as (0°, 0°). Since angle information for each of pixels is acquired even in a displaced state such as this, in the creation of a three-dimensional range image, a three-dimensional range image that is the same as the TOF sensor 10, in which no positional deviation has occurred, can be created.

### INDUSTRIAL APPLICABILITY

The angle information acquisition method of the present invention has the effect of allowing accurate angle information related to the distance measurement direction to be acquired for each of pixels, and can be applied to a range image sensor or the like.

### REFERENCE SIGNS LIST

10: TOF sensor
22: imaging element
50: inspection chart
50′: black-and-white chart image

1. An imager light receiving element type of range image sensor that acquires information about a light received by each of a plurality of pixels, the range image sensor comprising:
a distance calculation unit configured to calculate a distance to an object for each of pixels of a light receiving element; and
a memory unit configured to store the distance measured for each of the pixels and an angle information acquired for each of the pixels in association with the distance.

2. The range image sensor according to claim 1,
further comprising a transmission unit configured to transmit the distance measured for each of pixels and the angle information acquired for the pixel.

3. An angle information acquisition method, comprising:
a light receiving step of projecting light from a range image sensor onto a specific image whose position with respect to the range image sensor has been predetermined, and receiving the light reflected by the specific image with a light receiving element of the range image sensor;
an image creation step of creating a reflection intensity image corresponding to the specific image from information about an amplitude of a reflected light received by each of pixels in the light receiving element; and
an acquisition step of acquiring angle information about a direction in which each of the pixels measures distance, on the basis of the reflection intensity image.

4. The angle information acquisition method according to claim 3,
wherein the acquisition step involves acquiring, as the angle information, the direction of a prescribed position, for which the direction from the range image sensor is prescribed from out of the specific image, from the range image sensor, with respect to the pixel in a position of the reflection intensity image corresponding to the prescribed position.

5. The angle information acquisition method according to claim 4,
wherein the acquisition step involves acquiring the angle information with respect to the pixel in a position of the reflection intensity image corresponding to an unprescribed position, for which the direction from the range image sensor is not prescribed from out of the specific image, by complementing from the angle information acquired at the pixel in the position of the reflection intensity image corresponding to the prescribed position.

6. The angle information acquisition method according to claim 3,
wherein the angle information includes:
a first angle formed by a measurement direction of each of the pixels with respect to a specific axis perpendicular to a light receiving surface of the light receiving element; and
a second angle which is an angle of a circumferential direction around the specific axis and is a rotation angle from a reference position to the measurement direction.

7. The angle information acquisition method according to claim 6,
wherein the specific image has:
a first angle image that serves as a reference in acquiring the first angle; and
a second angle image that serves as a reference in acquiring the second angle.

8. The angle information acquisition method according to claim 7,
wherein an angle formed by the specific axis and a straight line passing through a point on the first angle image and an intersection between a specific axis and the light receiving surface, and the angle is a predetermined first specific angle,
a plurality of the first specific angles are provided, and
in the acquisition step, the first angle is acquired on the basis of the plurality of first specific angles.

9. The angle information acquisition method according to claim 8,
wherein the first angle image has a center point on the specific axis, and a plurality of concentric circles centered on the center point.

10. The angle information acquisition method according to claim 7,
wherein the second angle image has a straight line in which a reference line, which is perpendicular to the specific axis from a center point on the specific axis, has been rotated by a predetermined second specific angle centered on the center point, from the reference line,
a plurality of the second specific angles are provided,
in the acquisition step, the second angle is acquired on the basis of the plurality of the second specific angles, and
the reference position is a position on the reference line.

11. The angle information acquisition method according to claim 10,
wherein the second angle image has a plurality of straight lines disposed radially around a center point on the specific axis.

12. The angle information acquisition method according to claim 3,
wherein the specific image is formed on an image formation surface, and
the image formation surface is disposed opposite the range image sensor.

13. The angle information acquisition method according to claim 3,
wherein the specific image is an image formed by moving the range image sensor with respect to an image formation surface on which points are formed.

14. A range image sensor that acquires the angle information about each of the pixels by the angle information acquisition method according to claim 3, the range image sensor comprising:
a projection unit configured to project light onto an object;
a light receiving unit having a light receiving lens configured to collect light reflected by the object, and a light receiving element configured to receive light that has passed through the light receiving lens;
a distance calculation unit configured to calculate the distance to the object for each of pixels of the light receiving element; and
a memory unit configured to store the distance measured for each of the pixels and an angle information acquired for each of the pixels in association with the distance.

15. The range image sensor according to claim 14,
further comprising a transmission unit configured to transmit the distance measured for each of pixels and the angle information acquired for the pixels.
